(19) United States
(12) Patent Application Publication
(10) Pub. No.: US 2014/0178150 A1
(43) Pub. Date: Jun. 26, 2014

(54) WOOD SCREW

(71) Applicant: TAIWAN SHAN YIN INTERNATIONAL CO., LTD., KAOHSIUNG CITY (TW)

(72) Inventors: KOU-TSAIR SU, KAOHSIUNG CITY (TW); YU-JUNG SU, KAOHSIUNG CITY (TW)

(73) Assignee: TAIWAN SHAN YIN INTERNATIONAL CO., LTD., KAOHSIUNG CITY (TW)

(21) Appl. No.: 13/726,936

(22) Filed: Dec. 26, 2012

(51) Int. Cl. F16B 35/06

(52) U.S. Cl. CPC F16B 35/065
USPC 411/399

(57) ABSTRACT

A wood screw provides a plurality of auxiliary cutting areas disposed on a bottom surface of a head and a flat area formed in any two adjacent auxiliary cutting areas. Each auxiliary cutting area includes at least two cutting grooves disposed at intervals and formed on the bottom surface, and a cutting edge formed at a convergence of the connective cutting grooves. When the bottom surface contacts the surface of the wood, the cutting edge cuts and scrapes off burrs generated around the drilling hole, and the scraped burrs are accommodated in the cutting grooves to prevent the burrs from exposing to the head after screwing. Further, the head is tightly screwed on the wood to enhance the screwing stabilization.

### BACKGROUND OF THE INVENTION

1. Field of the Invention

The present invention relates to a screw, particularly to a screw used for screwing onto a wooden board.

2. Description of the Related Art

Referring to FIGS. 1 and 2, a conventional wood screw 1 comprises a head 11, a shank 12 extending from the head 11, and a drilling portion 13 disposed on a other side of the shank 12, opposite to the head 11; wherein, a plurality of threads 121 are spirally disposed on the shank 12. The head 11 includes a top surface 111, a conical bottom surface 112 disposed opposite to the top surface 111, and a plurality of ribs 113 disposed at intervals on the bottom side 112. Referring to FIG. 3, when the wood screw 1 is screwed onto a wooden board 2, the user directs the drilling portion 13 to the wooden board 2 and applies a torsion to the head for drilling into the wooden board 2 and generating a drilling hole 21. The thread 121 continuingly brings the shank 12 to screw into the drilling hole 21 until the head contacts the wooden board 2, and then the ribs 113 scrape off the burrs generated around the drilling hole 21. Therefore, the head are tightly abutted on the wooden board 2, whereby the wooden boards 2 are fastened via the wood screw 1.

However, the conventional wood screw 1 in screwing includes some disadvantages as follows:

1. The wooden board is composed of the resilient wooden fibers. The ribs are defined at intervals. While screwing, because the ribs are defined at intervals and the wood fibers are resilient, the ribs often cannot effectively cut and scrape off burrs generated around the drilling hole 21. Therefore, the head cannot be abutted on the drilling hole 21 because of the exposing burrs . Hence, the screwing effect is not well .

2. The head 11 does not provide a space for receiving the burrs cut off by the ribs 113. Accordingly, part of the burrs exposes to the head 11 and cannot achieve a good screwing effect.

### SUMMARY OF THE INVENTION

It is therefore the purpose of this invention to provide a wood screw that effectively scrapes off burrs generates around the drilling hole and provides a space enough for the cut-off burrs to prevent the burrs from exposing to the head, so that the head is able to firmly abut on the surface of the wooden board for achieving a better screwing effect.

The wood screw in accordance with the present invention comprises a head, a shank extending from the head, and a drilling portion disposed on the a side of the shank, opposite to the head; wherein, the head includes a top surface and a conical bottom surface disposed opposite to the top surface. The bottom surface includes a plurality of auxiliary cutting areas and a flat area formed between any two adjacent auxiliary cutting areas. Each auxiliary cutting area includes at least two cutting grooves defined at intervals on the bottom surface and a cutting edge formed at a convergence of the two connective cutting grooves. Because of the cutting edges and the cutting grooves disposed on the auxiliary cutting area, burrs generated around the drilling hole in screwing are effectively scraped by the cutting edges. Moreover, the scraped burrs are able to be accommodated in the cutting grooves, so that burrs will not expose to the head when screwed. Further, the head is tightly screwed on the wooden board to enhance the screwing fastening.

Preferably, a thread-free section is defined between the threads and the head.

Preferably, a reaming section is defined between the threads and the thread-free section on the shank. A plurality of helical conveying units are defined on the reaming section to be spaced apart. A spiral angle of the helical conveying units with respect to a center of the shank is greater than a spiral angle of the threads with respect to the center of the shank.

### BRIEF DESCRIPTION OF THE DRAWINGS

FIG. 1 is a schematic view showing a conventional wood screw;

FIG. 2 is a cross-sectional view showing the A-A section in FIG. 1;

FIG. 3 is a schematic view showing the conventional wood screw after screwed;

FIG. 4 is a perspective view showing a first preferred embodiment of the present invention;

FIG. 5 is a cross-sectional view showing the B-B section in FIG. 4;

FIG. 6 is a schematic view showing the first preferred embodiment of the present invention after screwed; and

FIG. 7 is a perspective view showing a second preferred embodiment of the present invention.

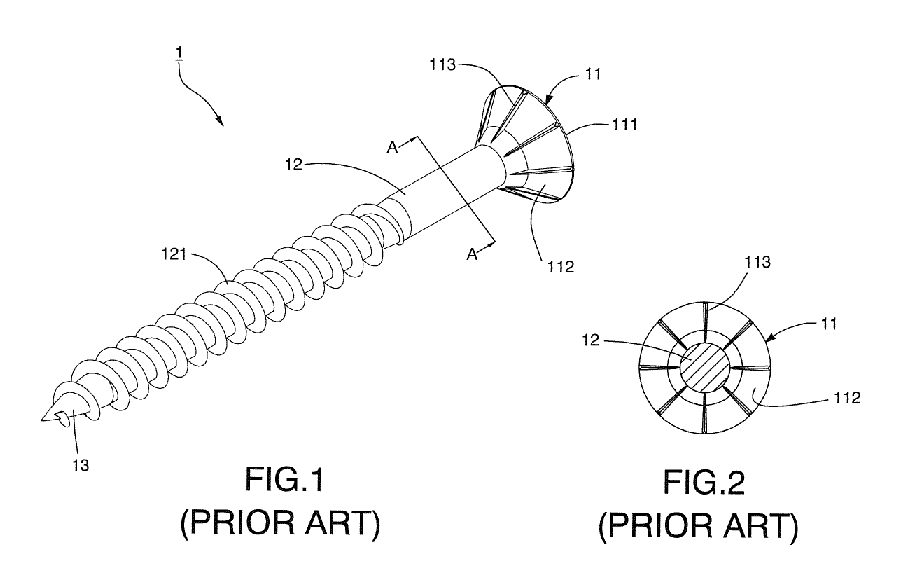

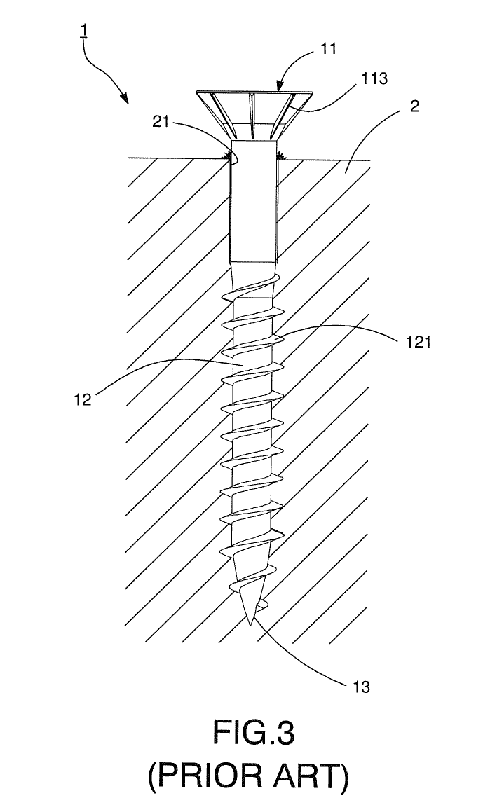

### DETAILED DESCRIPTION OF THE PREFERRED EMBODIMENTS

Wherever possible, the same reference numbers are used in the drawings and the description to refer to the same or like parts.

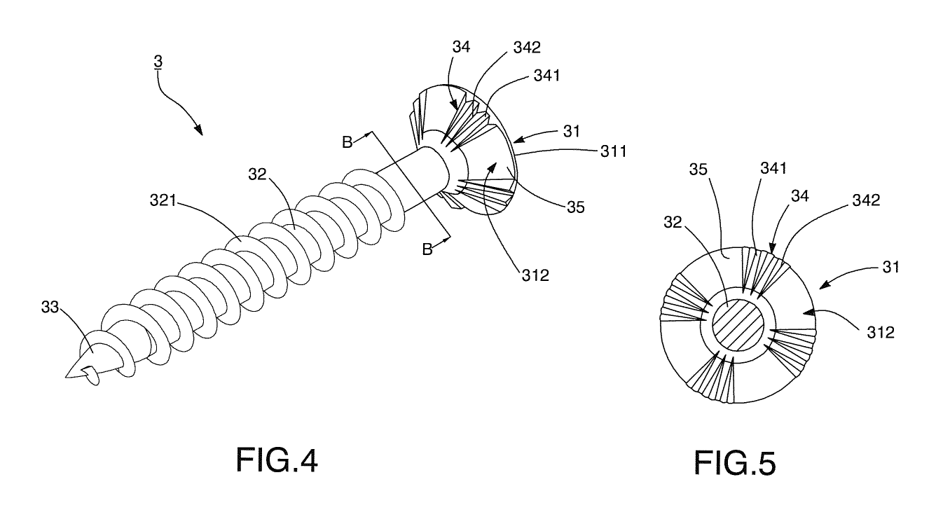

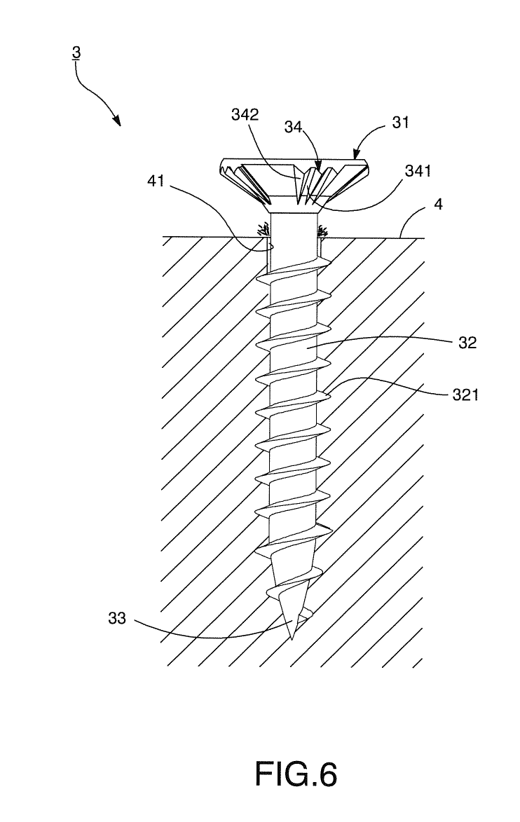

Referring to FIG. 4, a first preferred embodiment of the present invention is shown. A wood screw 3 comprises a head 31, a shank 32 extending from the head 31, and a drilling portion 33 disposed on a side of the shank 32, opposite to the head 31; wherein, a plurality of threads 321 are spirally disposed on the shank 32 by a certain spiral angle. The head 31 includes a top surface 311 and a conical bottom surface 312 extending downward from the top surface 311. Referring to FIG. 5, the bottom surface 312 includes a plurality of auxiliary cutting areas 34 and a flat area 35 formed between any two adjacent auxiliary cutting areas 34. Each auxiliary cutting area 34 includes at least two cutting grooves 341 disposed at intervals on the bottom surface 312 and a cutting edge 342 formed at a convergence of the two connective cutting grooves 341. In this embodiment, four auxiliary cutting areas 34 formed on the bottom surface 312 and three cutting edges 342 as well as two cutting grooves 341 formed on each auxiliary cutting area 34 are described as an example. Further, the drilling portion 33 is preferably designed in a conical shape in this embodiment.

Referring to FIG. 6, when the wood screw 3 is screwed onto a wooden board 4, the user directs the drilling portion 33 to the wooden board 4 and applies a torsion to the head 31, so that the drilling portion 33 and the threads 321 cut the wooden board 4 and generate a drilling hole 41 on the wooden board 4. Burrs are generated around the drilling hole 41 while the drilling portion 33 and the threads 321 cut the wooden board 4. The threads 321 drill along the drilling hole 41 and continuously bring the shank 32 to screw into the wooden board 4. Due to the arrangement of cutting edges 342 and cutting grooves 341 of each auxiliary cutting area 34, the cutting edge 342 connects to one another by an interruption of the cutting groove 341, namely the cutting edge 342 abuts on the cutting groove 341 and then the cutting groove 341 connects to another cutting edge 342, which allows the burrs to be severed by a tight pulling force of any two cutting edges 342 and solves the difficulty in cutting burrs due to the resilience of the wood fiber when the head 31 approaches to the drilling hole 41. Therefore, the burrs generated around the drilling hole 41 are efficiently scraped off. The burrs scraped by the cutting edges 342 can also be accommodated in the cutting groove 341. Therefore, no burrs exposes to the head 31 after screwing so that the head firmly abuts on the surface of the wooden board 4 and attains to enhance the screwing fastening of the wood screw 3 and the wooden board 4.

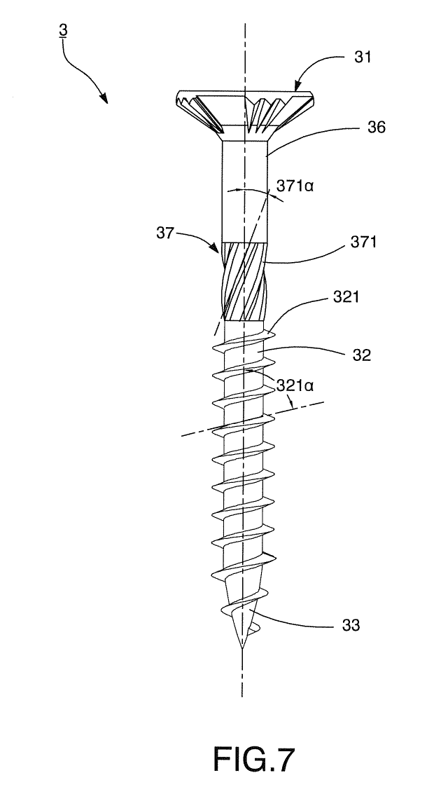

Referring to FIG. 7, a second preferred embodiment of the present invention still comprises a head 31, a shank 32, and a drilling portion, which have the same effects as the first preferred embodiment and herein is omitted. In the second preferred embodiment of the present invention, the shank 31 further includes a thread-free section 36 defined thereon, between the threads 321 and the head 31. A reaming section 37 is defined between the thread-free section 36 and the threads 321. A plurality of helical conveying units 371 are disposed at intervals on the reaming section 37. Further, a threaded angle 371a of the helical conveying units 371 with respect to a center of the shank 32 is larger than the threaded angle 321a of the threads with respect to the center of the shank 32. When the wood screw 3 is used to screw and fasten two wooden boards (not shown), the helical conveying units 372 scrape off burrs generated at the inner wall of the drilling hole on the wooden board so as to reduce the resistance of the shank 32 in screwing. Moreover, by means of the thread-free section 36, the two wooden boards are more tightly connected with each other to enhance the screwing force of the wood screw 3.

To sum up, the wood screw utilizes the auxiliary cutting areas and the ribs to scrape burrs generated around the drilling hole on the wooden board, so the scraped burrs are accommodated in the space of any two adjacent auxiliary cutting areas. Therefore, the head is tightly abutted on the surface of the wooden board to enhance the screwing fastening.

While we have shown and described the embodiment in accordance with the present invention, it should be clear to those skilled in the art that further embodiments may be made without departing from the scope of the present invention.

I claim:

1. A wood screw comprising a head, a shank extending from said head, and a drilling portion disposed on a side of said shank, opposite to said head; wherein, said head includes a top surface and a conical bottom surface extending downward from said top surface; a plurality of threads spirally disposed on said shank by a certain spiral angle;
wherein, said bottom surface includes a plurality of auxiliary cutting areas and a flat area formed between any two adjacent auxiliary cutting areas; each auxiliary cutting area includes at least two cutting grooves formed on said bottom surface and disposed at intervals, and a cutting edge formed at a convergence of said two connective cutting grooves.

2. The wood screw as claimed in claim 1, wherein, a thread-free section is defined between said threads and said head.

3. The wood screw as claimed in claim 2, wherein, a reaming section is defined between said threads and said thread-free section on said shank; a plurality of helical conveying units are defined on said reaming section to be spaced apart; a spiral angle of said helical conveying units with respect to a center of said shank is greater than a spiral angle of said threads with respect to said center of said shank.
